(19) United States
(12) Patent Application Publication
(10) Pub. No.: US 2026/0231867 A1
(43) Pub. Date: Aug. 13, 2026

(54) LIGHTING SYSTEM FOR PLANT GROWTH

(71) Applicant: Lifeponic Solutions, LLC, Colorado Springs, CO (US)

(72) Inventor: Michael L. ENOS, Colorado Springs, CO (US)

(21) Appl. No.: 19/153,520

(22) PCT Filed: Feb. 2, 2024
(86) PCT No.: PCT/US2024/014352

§ 371 Date: Aug. 4, 2025

Related U.S. Application Data
(60) Provisional application No. 63/442,820, filed on Feb. 2, 2023.

(51) Int. Cl. A01G 7/04; F21S 4/20; F21V 7/28; F21V 15/01; F21V 17/02; F21Y 103/10; F21Y 115/10; H05B 47/16

(52) U.S. Cl. CPC A01G 7/045; F21S 4/20; F21V 7/28; F21V 15/012; F21V 17/02; H05B 47/16; F21Y 2103/10; F21Y 2115/10

(57) ABSTRACT

Lighting systems for the growth of plants, particularly for the indoor growth of plants such as by using a hydroponic tower or similar growth systems. The lighting systems include pivotable sidewalls that may enclose a plant growth system and that include grow lights on an interior surface of the sidewalls to provide enhanced lighting to the plants.

### CROSS-REFERENCE TO RELATED APPLICATIONS

This application claims the priority benefit of U.S. Provisional Patent Application No. 63/442,820 by Enos, which is incorporated herein by reference in its entirety.

### FIELD

The present disclosure relates to the field of plant growth, particularly lighting systems configured for indoor plant growth.

### BACKGROUND

Indoor plant growth is an expanding market, particularly systems such as hydroponic structures for the indoor growth of edible plants such as vegetables, spices, fruits and the like. Such indoor growth structures typically require an artificial source of light to promote healthy plant growth. Many of these structures are constructed as a vertical tower, wherein plants are horizontally spaced around the circumference of the tower and vertically spaced along the height of the tower. See, for example, U.S. Pat. No. 10,772,270 by Linneberg, which is incorporated herein by reference in its entirety.

### SUMMARY

Several challenges have been identified relating to lighting systems for indoor plant growth, particularly for plant growth systems that implement a vertical tower upon which the plants are disposed. First, uniform plant growth requires that each vertically and horizontally spaced plant receive adequate light and that each plant receives approximately the same amount of light. Second, users report that while they enjoy their indoor plant growing systems, the lighting systems can be visually distracting, particularly when the plant growth system is placed in a heavily trafficked location in the home. In addition to being distracting, the lights may cause other issues for users such as migraine headaches, neurological issues, and the like. Further, current indoor lighting configurations lose a significant amount of light to the surrounding environment which results in unnecessary energy consumption.

It is an objective of the present disclosure to provide a lighting system for indoor plant growth that addresses these concerns.

In one embodiment, a lighting system for plant growth is disclosed. The lighting system includes an enclosure structure that is configured to surround a plant growth system and having at least a first sidewall, the first sidewall comprising a first sidewall interior surface and a first sidewall exterior surface. At least a first grow light disposed on the first sidewall interior surface.

The foregoing embodiment of a lighting system is subject to a number of characterizations and refinements. In one characterization, the enclosure structure includes at least a second sidewall that is operatively attached to the first sidewall, the second sidewall including a second sidewall interior surface and a second sidewall exterior surface. The second interior sidewall comprises at least a second grow light disposed on the second sidewall interior surface. In a further characterization, the enclosure structure includes at least a third sidewall operatively attached to the second sidewall, the third sidewall including a third sidewall interior surface and a third sidewall exterior surface, wherein the third sidewall includes at least a third grow light disposed on the third sidewall interior surface. In yet another characterization, the enclosure structure includes at least a fourth sidewall operatively attached to the third sidewall, where the fourth sidewall includes a fourth sidewall interior surface and a fourth sidewall exterior surface, and wherein the fourth sidewall includes at least a fourth grow light disposed on the fourth sidewall interior surface.

In one refinement, the sidewalls have a substantially planar configuration, and in one particular refinement each sidewall has a substantially rectangular shape. In another refinement, one or more of the sidewalls has a curved configuration wherein the sidewall interior surface has a convex shape and the sidewall exterior surface has a concave shape.

In another refinement, at least two adjacent sidewalls are operatively attached by one or more hinges. In another refinement, at least two adjacent sidewalls are releasably attached by one or more fasteners.

In another refinement, the grow lights comprise grow light strips. In another refinement, the grow lights comprise light emitting diodes (LEDs). In yet another refinement, the grow lights are configured to emit light having wavelengths in the range of about 380 nm to about 800 nm.

In another refinement, the grow lights are operatively attached to a timer that controls power to the grow lights. In yet another refinement, the interior surfaces of the sidewalls include a reflective coating, e.g., a coating that is configured to reflect the light emitted by the grow lights.

In another refinement, the lighting system includes a cover that is sized and shaped to be placed over the top of the enclosure structure. In one implementation, the cover includes an interior surface having a reflective coating.

In another embodiment, a method for growing plants in an indoor growing structure is disclosed. The method includes placing a lighting system as disclosed above around an indoor growing structure. In one implementation, the indoor growing structure is a hydroponic tower.

### DESCRIPTION OF THE DRAWINGS

FIG. 1 illustrates a perspective view of a lighting system for plant growth according to an embodiment.

FIGS. 2A and 2B illustrate a top view of a lighting system for plant growth according to an embodiment.

FIGS. 3A and 3B illustrate a top view of a lighting system for plant growth according to an embodiment.

FIG. 4 illustrates a top view of a lighting system for plant growth according to an embodiment.

### DESCRIPTION

The present disclosure is directed to lighting systems for the growth of plants, particularly for the indoor growth of plants such as by using a hydroponic tower or similar growth systems. As is known in the art, plant growth systems such as vertical hydroponic towers may include a plurality of plants that are vertically spaced-apart along the tower. As the plants grow, it becomes increasingly difficult to provide lighting to the plants that is suitable for maximizing the size and quality of the plants.

Another difficulty is that users, particularly residential users, may find the use of grow lights within the residence to be problematic. While many users may wish to place the plant growth system in a trafficked area of the residence, such as in a living room, dining room or kitchen, the intensity of the grow lights may be considered a nuisance and may even cause headaches and similar neurological issues after prolonged exposure.

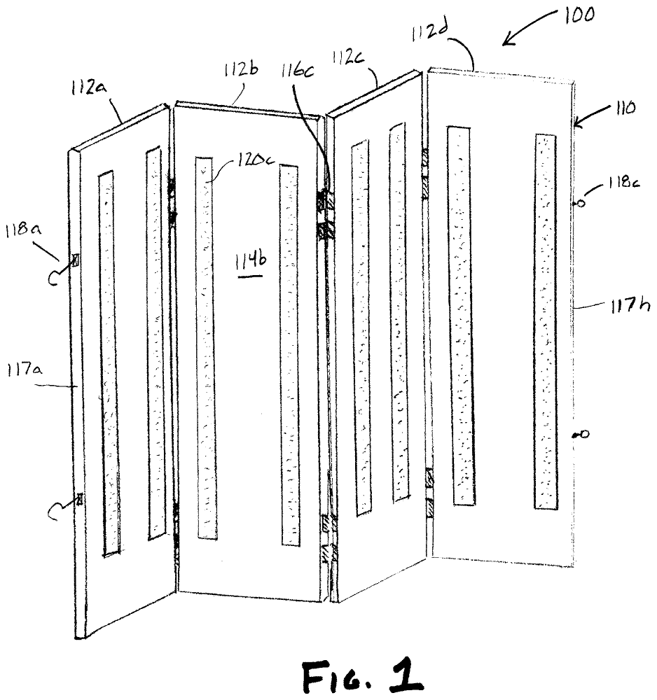

FIG. 1 illustrates a perspective view of a lighting system for plant growth according to an embodiment of the present disclosure. The lighting system 100 includes an enclosure structure 110 that is configured to substantially surround a plant growth system such as a hydroponic tower. The enclosure structure 110 illustrated in FIG. 1 includes four sidewalls (e.g., panels) 112a-112d that are operatively and pivotably connected by one or more hinges, e.g., hinge 116c disposed between, e.g., attached to, sidewalls 112b and 112c. Also as illustrated in FIG. 1, the ends of the four sidewall enclosure structure, e.g., the sidewall edges 117a and 117h, include one or more optional fastener elements, e.g., fastener elements 118a and 118c, which are configured to releasably attach the two edges 117a and 117h to form a complete enclosure around a plant growth system.

Each of the sidewalls has an interior surface, e.g., interior surface 114b, and an exterior surface on the opposite side of the sidewall from the interior surface. At least a first grow light, e.g., grow light 120c, is disposed on the interior surface of each of the sidewalls. As is illustrated in FIG. 1, each sidewall 112a-112d includes two grow lights, e.g., two vertically-oriented grow light strips, attached to the interior surface. The grow lights are operatively attached to a power source to energize the grow lights.

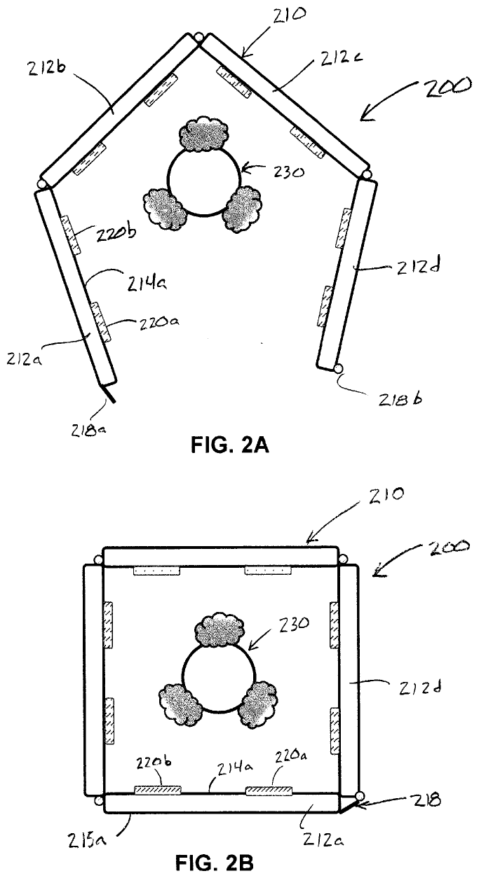

FIGS. 2A and 2B illustrate top views of a lighting system for plant growth according to an embodiment of the present disclosure. Similar to the embodiment illustrated in FIG. 1, the lighting system 200 includes an enclosure structure 210 having four sidewalls 212a-212d that are operatively inter-connected. Each sidewall has an interior surface facing the plant growth system 230, e.g., interior surface 214a, and an exterior surface on the opposite side of the sidewall from the interior surface, e.g., exterior surface 215a. As is illustrated in FIG. 2, each sidewall 212a-212d has two grow lights, e.g., two grow light strips 220a and 220b, attached to the interior surface of the sidewalls. The grow lights are operatively attached to a power source (not illustrated) to energize the grow lights.

FIGS. 2A and 2B particularly illustrate the plant growth structure 230 being placed and enclosed within the enclosure structure 210. In this regard, a fastener 218 comprising mating fastener elements 218a and 218b is utilized to secure the sidewall 212a to the sidewall 212d after the plant growth structure 230 is placed within the enclosure.

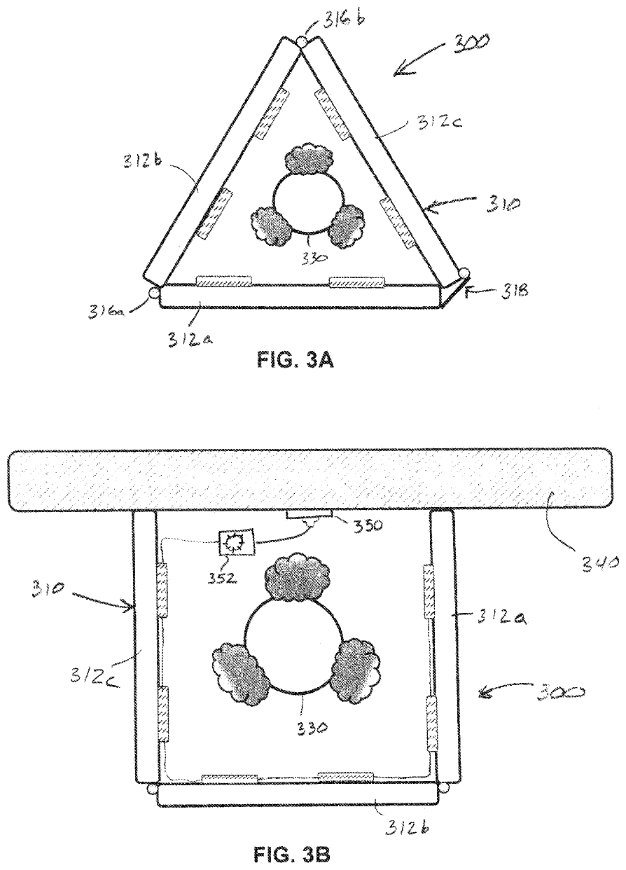

FIGS. 3A and 3B illustrate a top view of another embodiment of a lighting system for plant growth. The lighting system 300 is similar to the lighting systems illustrated in FIGS. 1, 2A and 2B, where the lighting system 300 includes three sidewalls 312a-312c. As illustrated in FIGS. 3A and 3B, the sidewall 312a is operatively attached to the sidewall 312b using a hinge 316a, and the sidewall 312b is attached to the sidewall 312c using a hinge 316b. The sidewall 312a is releasably attached to the sidewall 312c using a fastener 318 so that the enclosure can be opened for access to the plant growth structure 330. FIG. 3B illustrates that the lighting system 300 may be used in an alternative configuration where the enclosure structure 310 is configured such that the structure is placed against or near a structural wall 340 to substantially enclose the plant growth structure 330 therein. For example, the wall 340 may include a window to provide natural sunlight to the plant growth structure 330. Further, a similar configuration may include a mirror surface or a light reflective film forming a barrier to complete the enclosure. Th embedment illustrated in FIG. 3B also illustrates a power source 352 connected to a standard power outlet 350 for supplying power to the light strips. The power source may also include a timer to regulate the time and the length of time that the light strips are activated.

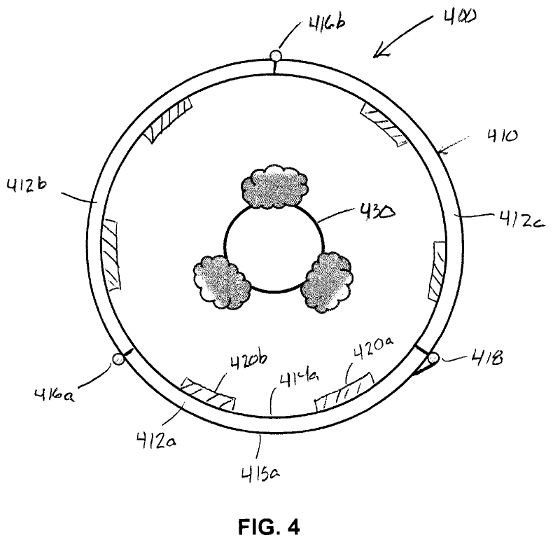

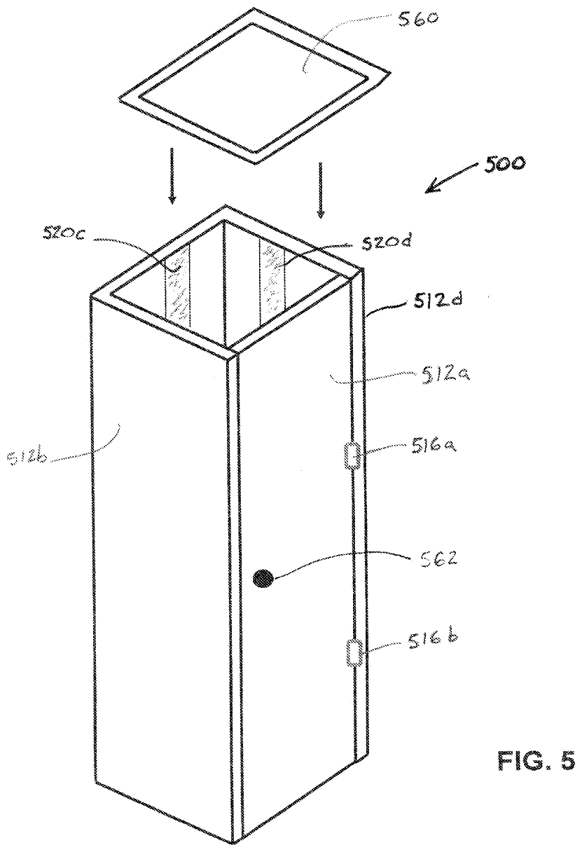

In the embodiments illustrated in FIGS. 1 to 3B, the enclosure structure is illustrated as comprising three or more sidewalls, where the sidewalls are substantially planar, to form a polygonal enclosure, e.g., in the shape of a rectangle or a triangle. FIG. 4 illustrates a top view of an embodiment wherein the sidewalls have a non-planar, e.g., a curved configuration. As illustrated in FIG. 4, the enclosure structure 410 comprises three sidewalls 412a-412c. Sidewall 412a is attached to sidewall 412b using hinge 416a, and sidewall 412b is attached to sidewall 412c using hinge 416b. To enclose the plant growth system 430, sidewall 412a may be releasably attached to sidewall 412c using an optional fastener 418. As with the embodiments illustrated above, each of the sidewalls 412a-412c includes an interior surface, e.g., interior surface 414a, and an exterior surface, e.g., exterior surface 415a, wherein grow lights such as grow lights 420a and 420b are mounted on the interior surface of the sidewalls.

FIG. 5 illustrates another embodiment of a lighting system according to the present disclosure. The lighting system 500 illustrated in FIG. 5 includes an enclosure having four sidewalls, e.g., sidewalls 512a and 512b, that are configured in the shape of a vertically configured cuboid. One sidewall 512a is pivotably attached to an adjacent sidewall 512d using hinges 516a and 516b. Sidewalls 512b, 512c and 512d may be pivotably connected or non-pivotably connected. As with the embodiment illustrated in the foregoing figures, grow lights, e.g., grow lights 520c and 520d, are disposed on an interior surface of the sidewalls. Pivotably attached sidewall 512a essentially forms a door, e.g., having a handle 562, to enable access to the plant growth system disposed within the enclosure. As illustrated in FIG. 5, the lighting system also includes a removable cover 560 that may be placed over the sidewalls to inhibit light from escaping from the enclosure. As with the sidewalls, the removable cover 560 may have a white or a reflective interior surface to enhance delivery of light to the plant growth system. Further, the interior surface of the cover 560 may have one or more grow lights disposed thereon to further enhance the amount of light available to the plant growth system. It will be appreciated that such a cover may also be utilized with the lighting systems illustrated in FIGS. 1 to 4.

As will be appreciated from the foregoing description and the attached figures, the enclosure structure may comprise at least a first sidewall, e.g., a single sidewall having one or more grow lights disposed thereon, and may include a plurality of sidewalls such as two, three, four or more sidewalls. The sidewalls may have a substantially planar configuration, e.g., a planar rectangular shape. Alternatively, the sidewalls may have a curved configuration, e.g., wherein the sidewall interior surface has a convex shape and the sidewall exterior surface has a concave shape. Structural elements such as hinges may be utilized to operatively and pivotably attach adjacent sidewalls. When configured to surround a plant growth structure, at least two sidewalls may be releasably attached by one or more fasteners, such as a hook and eye fastener, a slide lock or the like. As a result, a user is able to simply release and pivot one sidewall to access the plant growth system, e.g., for replenishing a water supply, trimming, harvesting, or the like.

The grow lights may comprise grow light strips or a plurality of individual grow lights. Further, the interior surfaces of the sidewalls may include a single grow light, e.g., a single grow light strip, or may include two or more grow lights in the form of grow light strips or grow light bulbs. The grow lights are selected to enhance the growth of plants within a plant growth system, e.g., are selected to emit light that enhances growth of the roots, leaves and/or flowers of a plant. In one configuration, the grow lights comprise light emitting diodes (LEDs), such as grow lights that emit light having wavelengths in the range of about 380 nm to about 800 nm to facilitate the growth of the plants. In another configuration, the grow lights are operatively attached to a timer that controls the delivery of power to the grow lights. Examples of useful grow lights that may be implemented in the systems described herein include, but are not limited to the Barrina T5 LED Grow Lights Full Spectrum producing 20 watts per light strip, and the Sunblaster LED Lighting Strips producing 42 watts per light strip.

The exterior surface of the sidewalls may be provided with an aesthetic design, such as a shutter appearance or the like. The interior surface of the side panels may be provided with a reflective surface, e.g., may be painted with a reflective paint or a bright white paint, to enhance the delivery of light to the plants. The lighting system may also be provided with a cover that is sized and shaped to be placed over the top of the enclosure structure to reduce the escape of light from the interior of the enclosure. As with the interior surface of the sidewalls, the cover may comprise an interior surface that is highly reflective of the light, or may itself include one or more grow lights on an interior surface of the cover.

The lighting systems disclosed herein significantly enhance the growth of plants. The use of movable panels, e.g., sidewalls, enable a user to access the plant growth system when needed. The enclosure system may be self-standing (e.g., requiring no other support mechanism), lightweight and easy to move. The panels enable maximum light penetration to the plants, e.g., by providing high lux (luminescence flux) per unit area.

While various embodiments of a lighting system for plant growth have been described in detail, it is apparent that modifications and adaptations of those embodiments will occur to those skilled in the art. However, is to be expressly understood that such modifications and adaptations are within the spirit and scope of the present disclosure.

What is claimed is:

1. A lighting system for plant growth, comprising:
an enclosure structure configured to substantially surround a plant growth system and comprising at least a first sidewall having a first sidewall interior surface and a first sidewall exterior surface, and a second sidewall pivotally attached to the first side wall and having a second sidewall interior surface and a second sidewall exterior surface; and
at least a first grow light disposed on the first sidewall interior surface and at least a second grow light disposed on the second sidewall interior surface.

2. The lighting system recited in claim 1, comprising:
at least a third sidewall pivotably attached to the second sidewall and having a third sidewall interior surface and a third sidewall exterior surface; and
at least a third grow light disposed on the third sidewall interior surface.

3. The lighting system recited in claim 2, comprising:
at least a fourth sidewall pivotably attached to the third sidewall and having a fourth sidewall interior surface and a fourth sidewall exterior surface; and
at least a fourth grow light disposed on the fourth sidewall interior surface.

4. The lighting system recited in any one of claims 1 to 3, wherein each sidewall has a substantially planar configuration.

5. The lighting system recited in claim 4, wherein each of the sidewalls has a substantially rectangular shape.

6. The lighting system recited in any one of claims 1 to 4, wherein each of the sidewalls has a curved configuration and wherein each sidewall interior surface has a convex shape and each sidewall exterior surface has a concave shape.

7. The lighting system recited in any one of claims 1 to 6, wherein at least two adjacent sidewalls are pivotably attached by one or more hinges.

8. The lighting system recited in any one of claims 1 to 7, wherein at least two adjacent sidewalls are releasably attached by one or more fasteners.

9. The lighting system recited in any one of claims 1 to 8, wherein the grow lights comprise grow light strips.

10. The lighting system recited in any one of claims 1 to 9, wherein the grow lights comprise light emitting diodes (LEDs).

11. The lighting system recited in any one of claims 1 to 10, wherein the grow lights are configured to emit light having wavelengths in the range of about 380 nm to about 800 nm.

12. The lighting system recited in any one of claims 1 to 11, wherein the grow lights are operatively attached to a timer that controls power to the grow lights.

13. The lighting system recited in any one of claims 1 to 12, wherein the interior surfaces of the sidewalls comprise a reflective coating.

14. The lighting system recited in any one of claims 1 to 13, wherein the lighting system further comprises a cover that is sized and shaped to be placed over the top of the enclosure structure.

15. The lighting system recited in claim 14, wherein the cover comprises an interior surface having a reflective coating.

16. A method for growing plants in an indoor growing structure, comprising placing a lighting system as recited in any one of claim 1 to 15 around the indoor growing structure.
